(19) United States
(12) Patent Application Publication
(10) Pub. No.: US 2026/0080469 A1
(43) Pub. Date: Mar. 19, 2026

(54) METHOD AND SYSTEM FOR A DYNAMIC EXCHANGE SIMULATOR

(71) Applicant: Bull Teknoloji, Istanbul (TR)

(72) Inventors: ALI VOLKAN ATLI, Istanbul (TR); BERFIN DUMAN, Istanbul (TR); MEHMET HILMI DÜNDAR, Istanbul (TR); SEVKET YILMAZ GÜRAK, Istanbul (TR); SAVAS SASMAZ, Istanbul (TR)

(21) Appl. No.: 18/885,460

(22) Filed: Sep. 13, 2024

(51) Int. Cl. G06Q 40/04

(52) U.S. Cl. CPC G06Q 40/04

(57) ABSTRACT

A system for a simulated stock exchange (a digital twin) and methods for a plurality of test users performing forward testing of order transactions are described. The core of the system is comprised of an AI engine to generate and/or update a limit order book (LOB) according to criterion such as received orders, market conditions and time frame, and a matching engine that executes orders according to exchange's order matching rules. Liquidity generator is an optional component that adds large number of realistic orders to the system to increase liquidity. The AI engine is trained with time-stamped historic order data. The test user's access to the system is through a client application and uses open trading protocols to send orders and receive market data updates. The AI model uses deep learning with an autoregressive generative model for LOB transitions.

### TECHNICAL FIELD

The present invention generally relates to the field of electronic trading in financial markets. More specifically, the present invention is related to simulating an electronic exchange system.

### Definitions

A “security” refers to a stock, bond, and a derivative product such as option, future, etc. that is subject to buy and sell transactions in the securities market. Additionally, it may refer to an industry or sector-related item such as crude oil, agricultural product or gold. Without losing generality, all types of traded items are designated as securities. The terms security and asset are used interchangeably.

The “stock exchange” (or “exchange” in short) is a place where securities are exchanged. It acts as an intermediary so that securities issued by all entities can be listed and traded through buy and sell orders.

An “Order Book (OB)” refers to a listing of order messages. Each order includes information such as trader identifier, order identifier, type, price, quantity, and buy or sell direction. The term ‘Limit Order Book’ (LOB) is used interchangeable with OB. The LOB is “deep” when there are many levels (prices) for a given asset. Level 1 refers to highest bid and lowest ask price orders, level 2 refers to next highest bid and next lowest ask price orders, and so on. LOB is “big” (or broad) if the number of orders per level is high. The “Top of the Book (ToB)” is comprised of only level 1 orders.

“Market information” includes data for securities traded in an exchange. Market data broadly includes order books, prices, announcements, news, social media, SEC-filings and other relevant information about the market for all traded securities.

The term “liquidity” is used to express the desire of traders to interact regarding a certain asset. If an order book is both deep and big, the given asset is said to be liquid. A trader can easily buy or sell an asset when there is liquidity.

The “matching engine” is the software program that forms the heart of an electronic exchange that matches buy and sell orders on a continuous basis according to a ruleset, a service traditionally performed by trading floor professionals. The matching engine is critical for guaranteeing the efficient operation of an exchange since it matches buyers and sellers for all stocks.

A “market taker” is an order that is close to TOB. This order is likely to be matched with another order. When the order is executed, liquidity is removed from the LOB, and hence the word “taker”.

A “market maker” is an order that will not likely be matched. Market maker seeks to profit from the difference in the bid-ask spread. The purpose of a market maker is to infuse liquidity.

The term “artificial intelligence (AI)” refers to the general ability of computers to mimic human intelligence. The term “machine learning (ML)” refers to the specific technologies and algorithms to automatically learn insights and recognize patterns from data, applying that learning to make increasingly better decisions. Although ML is often used interchangeably with AI, ML is a simply a subset of the broader category of AI.

The term “static backtesting” refers to the process of testing a trading strategy on historical market data without considering real-time market conditions, order flow, or execution capabilities. It does not rely on generating LOBs.

The term ‘forward testing’ refers to the process of simulating a trading algorithm's behavior projected onto a future time of the market.

The term “HFT” refers to high frequency trading that uses sophisticated algorithms and fast computers to frequently generate large number of orders at one time. HFT and algorithmic trading are terms used interchangeably.

The “ITCH” protocol is short for “Intra-Trade Communication Handler. It provides high-performance data formatting to send primarily TOB (Level 1 LOB) information (although doesn't necessarily rule out sending Level 2 and 3 data)”. It is a multicast protocol using UDP over IP.

The “OUCH” protocol is short for “Order Update and Cancellation History”. It encodes order messages such as new order, order cancellation, and order modification. It is a unicast protocol using TCP over IP.

### DISCUSSION OF RELATED ART

It is one of the objectives of this invention to create a dynamic platform that simulates one or more exchanges (digital twins) for users to perform forward testing of financial trading strategies. It is designed to optimize decision-making processes in financial markets while allowing individual, corporate or HFT users to test trading strategies. Nowadays, many of the trading strategies use algorithms to evaluate the market data and determine optimized strategies. Such algorithmic trading is performed through state-of-the-art electronic systems that enable extra low-latency transactions. These systems quickly analyze market conditions, evaluate arbitrage opportunities and provide significant liquidity to the market. Algorithmic transactions form a significant portion of all transactions in stock exchanges worldwide including the New York Stock Exchange (NYSE) and the National Association of Securities Dealers Automated Quotations (NASDAQ).

Although there are static backtesting systems for testing algorithmic transactions, these systems provide results by applying the trader's strategy to historic market data at a certain point in the past. The test provides indications of profitability and risk if the order were to be placed at that time. These systems do not consider current state of the market. That said, some static backtesting systems have direct network connections to one or more exchanges to receive live data [see e.g. www.quantconnect.com, www.broadridge.com, www.metatrader4.com]. However, these connections are highly priced. Yet, even such systems produce test results of the near-past conditions of the market as the market is highly dynamic wherein the market moves in nanoseconds. Another disadvantage is that, during testing, a LOB reflecting the actual market for the specific security is not generated by any of these systems. Therefore, it does not realistically emulate a dynamic market environment. It is essentially a simulation of how the strategy would have performed, given a specific set of rules and historical prices.

The objective of this invention is to create a digital twin of the exchange that emulates a realistic near-real-life exchange experience to users by providing liquidity while providing forward-testing opportunities without needing to pay the high cost of network exchange connections to receive live market data.

A need is identified to generate a realistic market experience in an exchange simulator by creating a trading volume, i.e., providing a LOB when the user is ready to test a trading strategy. The goal is to test days and events that have not yet happened. This is achieved through training an AI model with historical market data so that the model can generate LOBs corresponding to any desired future time horizon.

There are several prior arts that attempt to simulate an electronic exchange. For example, Mintz et al., in U.S. patent application No. 2004/0064395 A1, titled ‘System and Method for Simulating an Electronic Trading Environment’, dated Apr. 1, 2004, provides a system and methods for recording live market data directly from an exchange, and generating orders based on collected data to simulate the recorded market. The goal is providing an off-line trading environment without the associated risks of trading in a live market. Their system has two key components: ‘market simulator’ which collects order data from a plurality of exchanges in real-time, and an ‘exchange simulator’ which performs order matching, i.e., acts as a ‘matching engine’ using the rules of the simulated exchange. Market simulator generates orders by reverse engineering the recorded market information back into orders. The generated orders are then sent to the exchange simulator which matches the orders and disseminates fill and/or price information. As a result, generated orders, the fill and/or price information from the simulation will match precisely (or almost precisely) to the order and fill and/or price information as it occurred in the real market at the time the past data was recorded. The exchange allows one or more traders to participate in this simulated trading environment by entering orders. Although the goals and advantages of Mintz match the present invention, their system is static (information is created for a past time) and architecture is completely different. Our invention relies on an AI engine to generate LOBs by pre-processing the market data to extract the market's behavior, specifically the state changes in the LOB to generate a LOB representing the future, as opposed to the past as in Mintz.

In the present invention, the AI engine is trained by historic time-stamped message data for a large group of assets and able to generate LOBs for any future date. Doing so, the correlation (cross elasticity) between prices of different assets is also incorporated. Furthermore, a separate subcomponent, referred as liquidity generator instantly generates orders in real-time based on the LOB generated by AI engine using a specific criterion or algorithm to generate volume. In stark contrast, Mintz relies only on live market data and therefore needs continuous network connectivity to a plurality of exchanges.

Another reference is Kim et al., in Japanese patent applications No. 2023/155162A, titled ‘Method and System for Highly Frequent Securities Transaction’, filed on Oct. 20, 2023, that provides a method and a system for a High Frequency Trading (HFT) which can generate order data on the basis of prediction data for an asset by using a machine learning model which uses as input some market data from an exchange and/or a web site. The system generates prediction data for the asset (such as price) in future time intervals to factor in the delay in processing and getting a response from the exchange to an order, generating order data for the target item based on the generated prediction. Although Kim uses machine learning for predicting data associated to an asset, and the exchange's behavior at a future time, their system is always connected to a plurality of stock exchanges to receive live input data. In contrast, the present invention relies purely on historic time-stamped market data to alleviate the need to connect to exchanges and pay hefty connection charges.

Another prior art reference is Khan et al., in U.S. Pat. No. 9,754,323 B2, titled ‘Rule Based Exchange Simulator’, dated Sep. 5, 2017, that provides a system for a rule-based exchange simulator. A plurality of rules, stored in a rules-engine, define how orders should be processed at the exchange simulator. Rules may comprise a fill rule, a cancel rule, a reject rule, a no acknowledgment rule, a market data rule and so on. When a transaction request that comprises a buy or sell order for a particular security is received by the stock exchange simulator, it is fulfilled according to one or more rules stored in the rules-engine. Khan describes a rudimentary exchange simulator that only accounts for the behavior of the matching engine component. The historic market data is not processed to generate an order book for a future point in time.

One of the references that describes collaborative testing of a group of test users is Whitfield, in U.S. patent application No. 2020/0151815 A1, titled ‘Systems and Methods for a Hybrid Social Trading Platform’, dated May 14, 2020, that describes a hybrid trading and social media platform that enables users to execute trades in a collaborative manner, benefiting from the collective knowledge of the platform community. A leader-follower relationships are established in a dynamic manner among the platform users. Users can exchange trading ideas and/or actual trades, and comments and feedback on trades. Although Whitfield's platform provides a similar feature to the present invention from the perspective of test users seeing each other's live test orders, this platform differs as Whitfield does not provide an exchange simulator.

Finally, Myr, in U.S. Pat. No. 7,739,182 B2, titled ‘Machine Learning Automatic Order Transmission System for Sending Self-Optimized Trading Signals’, dated Jun. 15, 2010, provides a multi-channel machine learning system for automated simultaneous transmission of a few orders generated according to differently self-optimized trading parameters. A machine learning system optimizes each of buy/sell trading strategy parameters based on real-time market data collected from exchanges via connections. Although, machine learning is used for optimizing trade parameters during static backtesting, it is not used to create order books based on historic data as in the present invention.

In view of foregoing, there exists a need in the art for a computer-implemented system and methods for a dynamic exchange simulator (digital twin) for forward testing that does not need live connectivity to one or more exchanges. The system is intended for traders to test their strategies before applying to the real market. It can also be used by regulators, consultants, students, and academicians who teach and perform research on market dynamics and trading.

The present invention provides functionalities of a Matching Engine, and an AI-based model trained using historical market data to generate limit order books (LOBs) projected to any future time. The present invention is made possible due to recent developments in AI technologies (specifically chatbots such as Gemini and ChatGPT). The Large Language Models (LLMs), techniques such as tokenization and autoregressive generative models are among the key enablers. The present invention includes a liquidity generator subcomponent that injects liquidity based on highly impact making financial news/social media/SEC-filings/new rules, etc.

There are now several credible financial datasets available such as LOBSTER and FI-2010 datasets from NASDAQ. Many national exchanges (such as BORSA Istanbul) are providing their historical market data for research and development at no or minimal cost. The raw data in these datasets are time-stamped order messages for stocks.

The system of invention has several other key components such as Order Manager for receiving order messages using any open or proprietary order entry protocol one of which is known as the OUCH [see NASDAQ OUCH 5 Protocol Specification] published by NASDAQ; a Feeder for multicasting the updated LOB to all users using any open or proprietary real-time exchange data distribution protocol one of which is known as the ITCH [see NASDAQ TotalView ITCH 5 Protocol Specification]; a Communications Interface to communicate with test users, said communications interface providing access to the system of invention through TCP/IP, and a user interface (UI) designed for test users and system administration. The system allows test users to see each other's orders to create a life-like dynamic trading experience. All these components are necessary to emulate the real exchange behavior.

Throughout the document the terms OUCH and ITCH are used to imply order entry and real-time exchange data protocols, respectively. However, without losing generality, the system and methods support all other similar protocols.

The system allows forward testing, meaning, it is capable of predicting market conditions projected to one or more future points in time based on the output of the AI engine which generates the LOB. The test user generates an order for an asset and transmits it to the simulated exchange. That order is added to the current LOB. Liquidity indirectly implies that there is a LOB corresponding to an asset with a listing of buy and sell orders pending to be matched. In a simulated exchange model, generating liquidity is crucial for a realistic market behavior.

According to an aspect of the present invention, liquidity is also generated as test participant/users perform order entry. According to another aspect of the present invention, liquidity may also be generated by a sub-component of the system.

Embodiments of the present invention are an improvement over prior art systems and methods.

### SUMMARY OF THE INVENTION

In one embodiment, the present invention provides an article of manufacture having non-transitory computer readable storage medium comprising computer readable program code executable by a processor to implement an exchange simulator for forward testing on future market conditions generating limit order books (LOBs), and having no direct attachment to any real exchange to receive real-time market order data, the medium comprising: (a) computer readable program code receiving, at a communication interface of the exchange simulator, a plurality of order messages from a plurality of test client devices; (b) computer readable program code parsing the plurality of order messages and outputting a plurality of parsed order messages to an order manager; (c) computer readable program code receiving the parsed order messages at a matching engine associated with the exchange simulator, and adding to a current limit order book (LOB), the current LOB being generated by an artificial intelligence (AI) engine; (d) computer readable program code matching the parsed order messages using a matching engine and updating the current LOB; wherein the matching engine applies one or more rules associated with the simulated exchange during matching; (e) computer readable program code sending the updated current LOB to AI engine; wherein the AI engine generates a new LOB to simulate market reaction to said current LOB; (f) computer readable program code receiving the new LOB at a feeder and generating an outbound message comprising the new LOB; and (g) outputting, via the communication interface, the outbound message comprising the new LOB message to the plurality of test client devices. In this context, parsing means reading the data/fields from the order messages.

In another embodiment, the present invention provides a system acting as an exchange simulator for forward testing on future market conditions generating limit order books (LOBs) s and having no direct attachment to any real exchange to receive real-time market order data, having at least: (a) a memory; (b) a central processing unit (CPU) comprised of at least three cores wherein each core having a different function and acting independently, the CPU comprising: (i) a first core implementing an order management system, receiving order messages from a plurality test client computing devices; (ii) a second core implementing a matching engine that matches incoming orders to execute simulated trades; (iii) a third core implementing a feeder, sending the LOBs to test users; (c) a graphical processing unit (GPR) implementing an AI engine; wherein computer readable program code stored in the memory, which when executed by the CPU: (1) receives, via a communication interface associated with the first core of the CPU, a plurality of order messages from a plurality of test client devices; (2) parses the plurality of order messages via the first core of the CPU and outputting a plurality of parsed order messages; (3) receives the parsed order messages at the second core of the CPU, and adding to a current limit order book (LOB), the current LOB being generated by an artificial intelligence (AI) engine; (4) matches the parsed order messages using the second core of the CPU and updates the current LOB; wherein the second core applies one or more rules associated with a simulated exchange during matching; (5) sends the updated current LOB to the AI engine on the GPU; wherein the AI engine generates a new LOB to simulate market reaction to said current LOB; (6) receives the new LOB at the third core of the CPU and generates an outbound message comprising the new LOB; wherein the third core of the CPU sends the outbound message comprising the new LOB to the plurality of test client devices.

In one embodiment, the AI engine is trained offline with a large training dataset of historic order messages obtained from an exchange being simulate

In one embodiment, the offline training is performed per security asset to generate a LOB corresponding to the security asset, and wherein the offline training being performed either serially or in parallel for all security assets.

In one embodiment, the offline training is performed per security asset group of highly correlated securities to generate LOBs corresponding to the security asset group, wherein the offline training being performed either serially or in parallel for all security asset groups.

In one embodiment, the highly correlated securities in the security asset group are identified by their correlation coefficient being close to ±1, wherein the highly correlated securities in the security asset group tend to move in a same or opposite price direction by similar amounts.

In one embodiment, offline training is performed by a training system using a time series of historic order messages and corresponding time series of order books as input, and the next order book in the time series as output.

In one embodiment, the historic order messages are first tokenized and then masked before being used as input into the training system.

In one embodiment, the time series of order book is deterministic and generated by a matching engine (LOB) simulator using the time series of order messages.

In one embodiment, the parsed order messages are additionally generated by an internal liquidity generating agent generating bulk orders to improve liquidity in the current LOB.

In one embodiment, the matching engine matches buy and sell orders according to current LOB using the one or more rules associated with the simulated exchange during matching.

In one embodiment, the internal liquidity generator has a sentiment analyzer reacting to market-changing key events such as natural disasters, pandemics, geopolitical events, regulation changes, and technology disruptions by processing additional market information such as news, social media feeds and regulatory filings, and determining an impact score on a specific security.

In one embodiment, the liquidity generator is further configurable as one of a market maker, random order generator or a high frequency trader, or a combination thereof.

### BRIEF DESCRIPTION OF FIGURES

The present disclosure, in accordance with one or more various examples, is described in detail with reference to the following figures. The drawings are provided for purposes of illustration only and merely depict examples of the disclosure. These drawings are provided to facilitate the reader's understanding of the disclosure and should not be considered limiting of the breadth, scope, or applicability of the disclosure. It should be noted that for clarity and ease of illustration these drawings are not necessarily made to scale.

FIG. 1 depicts the block diagram showing LOB transition.

FIG. 2 depicts the matching engine operations according to prior art.

FIG. 3 depicts a matching engine operation for an order according to prior art.

FIG. 4 depicts another matching engine operation for another order according to prior art.

FIG. 5 depicts the block diagram showing LOB transitioning according to the present invention.

FIG. 6a depicts the block diagram of AI training process according to the present invention.

FIG. 6b depicts the block diagram of AI model according to the present invention.

FIG. 7a depicts the first embodiment of the present invention showing key components of the system.

FIG. 7b depicts the second embodiment of the present invention showing key components of the system.

FIG. 8a depicts the flow diagram showing the test user entering an order.

FIG. 8b depicts the flow diagram showing the test user and liquidity generator entering a plurality of orders.

FIG. 9 shows the hardware diagram of the system of the present invention.

FIG. 10a shows a first screen shot of an exemplary test user interface.

FIG. 10b shows a second screen shot of an exemplary test user interface.

FIG. 10c shows a third screen shot of an exemplary test user interface.

Skilled professionals will appreciate that elements in the figures are illustrated for simplicity and clarity and have not necessarily been drawn to scale. Also, common but well-understood elements that are useful or necessary in a commercially feasible embodiment are often not depicted to facilitate a less obstructed view of these various embodiments of the present invention. Flowchart and block diagrams in the figures illustrate the functionality and operation of possible implementations of systems, methods and computer program products according to various embodiments of the present invention. It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

### DETAILED DESCRIPTION

The detailed descriptions contain explanations, formulas, diagrams, and flowcharts that are provided purely to enhance the understanding of the system components and the methods, and thus they may not describe all details or illustrate all trivial blocks and steps that would be understood by those persons skilled in art. Some of the figures are presented only for clarifying the terminology or to explain the prior art in contrast to present invention.

While this invention is illustrated and described in a preferred embodiment, the invention may be produced in many different configurations. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

Various modifications to embodiments will be readily apparent, and the generic principles defined herein may be applied to other aspects. Thus, the invention is not intended to be limited to the aspects shown herein but is to be accorded the full scope consistent with the language claims, where reference to an element in the singular is not intended to mean ‘one and only one’ unless specifically so stated, but rather ‘one or more.’ Unless specifically stated otherwise, the term ‘some’ refers to one or more.

A phrase, for example, an ‘aspect’ does not imply that the aspect is essential to the subject technology or that the aspect applies to all configurations of the subject technology. A disclosure relating to an aspect may apply to all configurations, or one or more configurations. A phrase, for example, an aspect may refer to one or more aspects and vice versa. A phrase, for example, a ‘configuration’ does not imply that such configuration is essential to the subject technology or that such configuration applies to all configurations of the subject technology. A disclosure relating to a configuration may apply to all configurations, or one or more configurations. A phrase, for example, a configuration may refer to one or more configurations and vice versa.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the invention.

While this specification contains many specific implementation details, these should not be construed as limitations on the scope of any invention or of what may be claimed, but rather as descriptions of features that may be specific to embodiments of inventions. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the order shown or in sequential order, or that all illustrated operations be performed, to achieve desirable results. In certain circumstances, multitasking and parallel processing may be advantageous. Moreover, the separation of various system components in the embodiments described below should not be understood as requiring such separation in all embodiments, and the described program components and systems can generally be integrated together in a single software product or packaged into multiple software products.

As noted above, embodiments of the subject matter have been described, but other embodiments are within the scope of the following claims. For example, the actions recited in the claims can be performed in a different order and still achieve desirable results. As one example, the processes depicted in the accompanying figures do not necessarily require the order shown, or sequential order, to achieve desirable results. In certain implementations, multitasking and parallel processing may be advantageous.

Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein.

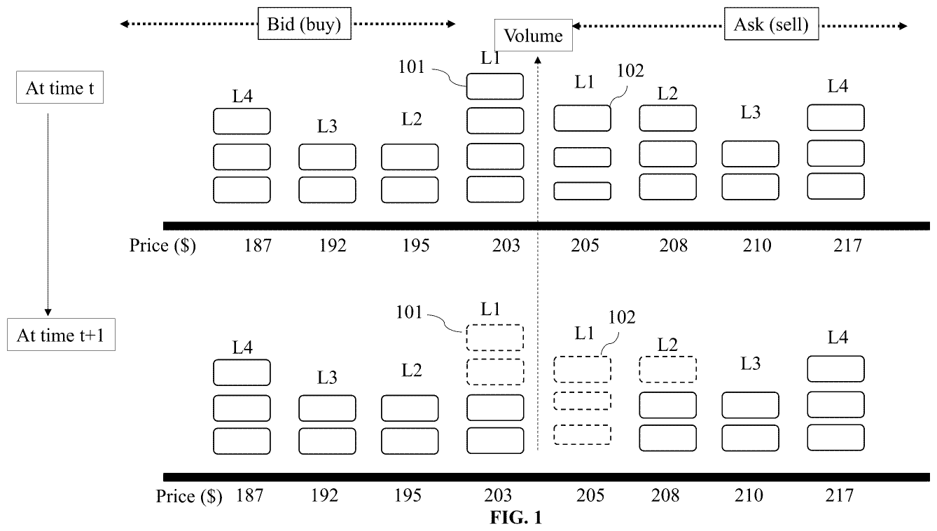

FIG. 1 illustrates the dynamics of an exemplary limit order book (LOB) according to prior art by adding some orders at time t. LOB can be envisioned as the collection of orders that are yet to be matched for a security [see Donadio et al., “Developing High-Frequency Trading Systems,” Packet Publishing, Mumbai, 2022]. The diagram shows the LOB at time t (before new orders arrived), and the LOB at time t+1 (after new orders are executed). The upper chart shows the LOB at time t and lower chart shows the LOB at time t+1. Each square in the plot represents an order of a certain volume. The bars on the left side represent bid orders and the bars on the right side represent ask orders. Orders are sorted into different price levels based on their submitted prices, where L1 (Level 1) represents the first level, L2 (Level 2) represents the second level, and so on. Each level contains two values: price ($) and volume (each order's volume is shown as a square). The orders at the same level may arrive at different times. These are ordered according to arrival times, the earliest order being on the top of the list. On the bid side, L1 is the highest priced orders, L2 is the second highest priced orders, and so on. On the ask side, L1 is the lowest priced orders, L2 is the second lowest priced orders and so on. On the bid side, order 101 has the highest price offered ($203) at time t and arrived first. On the ask side, order 102 at level L1 is the lowest price offered ($205) at time t and arrived first.

In summary, in a price-time priority book, ordering is first by their price, and second by their arrival time. For buy (bid) orders, the orders are prioritized according to price with the highest price first, the next highest second and so on. For sell (ask) orders, the orders are prioritized according to price with the lowest price first, the next lowest price second and so on. An incoming order is matched with one or more existing orders in the ordered book according to price-time priority. Upon matching two orders (a buy and a sell), a trade occurs, and the ownership of the underlying security is transferred from the seller to the buyer.

The bottom chart of FIG. 1 shows the LOB after the matching actions of three incoming market orders: (i) cancel order 101 (priced at $203), (ii) new buy order of all available shares at $205, and (iii) new buy order for some shares at $208. As a result, the L1 and L2 ask levels and the L1 bid level have changed after executing the trades. The boxes with dotted lines show those volumes that are removed from the LOB after trade.

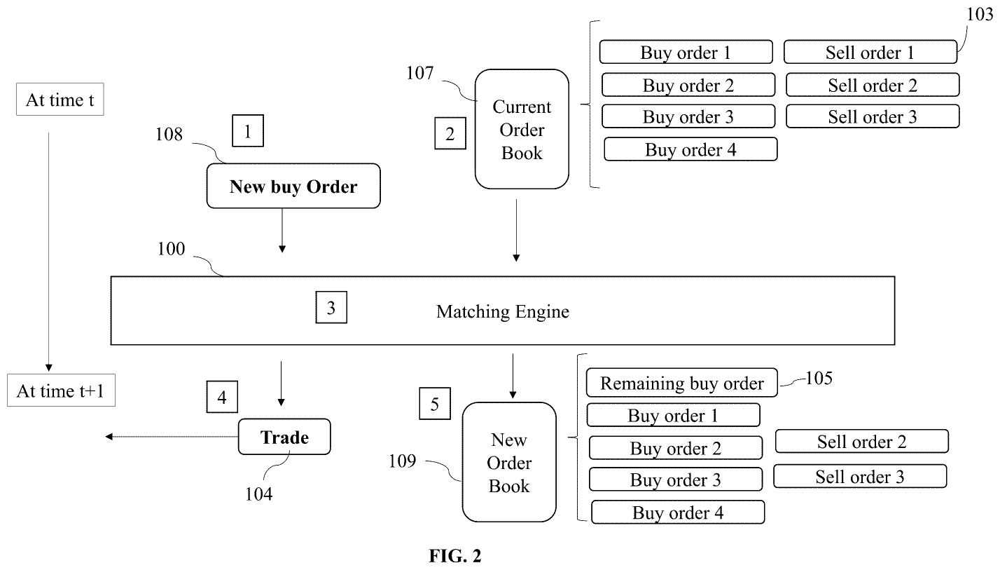

FIG. 2 shows the general operations of matching engine 100 of an exchange according to prior art. In Step 1: New buy order 108 arrives at the matching engine at time t. Step 2: Matching engine retrieves the current LOB, which is shown in box 107. The LOB includes buy (bid) and sell (ask) orders ordered according to price-time-of-arrival priority as detailed in FIG. 1. Step 3: Matching engine compares new buy order 108 with current LOB 107 to see if there is a match with a sell order. It determines that the order can be partially fulfilled with sell order 103, but there is not enough sell orders at the requested price. Step 4: The trade is executed at box 104 where the stocks of box 103 change hand from seller to buyer. Step 5: Matching engine 100 updates the LOB, i.e., generates new LOB 109, by deleting sell order 103, and inserting the remainder of the buy order 108 that is not fulfilled as new buy order 105.

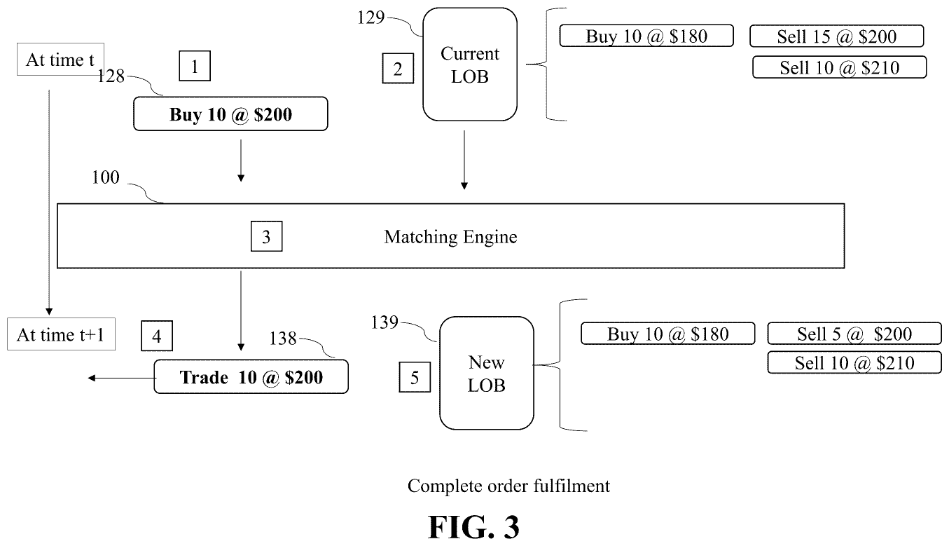

FIG. 3 shows an exemplary order fulfilment operations of the matching engine according to prior art. Step 1: New buy order 128 arrives at matching engine 100 at time t with a bid of 10 stocks at $200. Step 2: Matching engine 100 retrieves current LOB 129 which consists of a buy order comprised of 10 stocks at $180, sell 15 at $200 and sell 10 at $210. Step 3: Matching engine compares new buy order 128 with current LOB 129 to see if there is a price march with a sell order. It determines that the order can be fulfilled with sell order of 15 at $200. Step 4: The trade is executed at box 138 where the stocks change hand from seller to buyer. Step 5: Matching engine 100 updates the LOB, i.e., generates new LOB 139 by updating the sell order of 15 stocks at $200 to the remaining 5 stocks at $200.

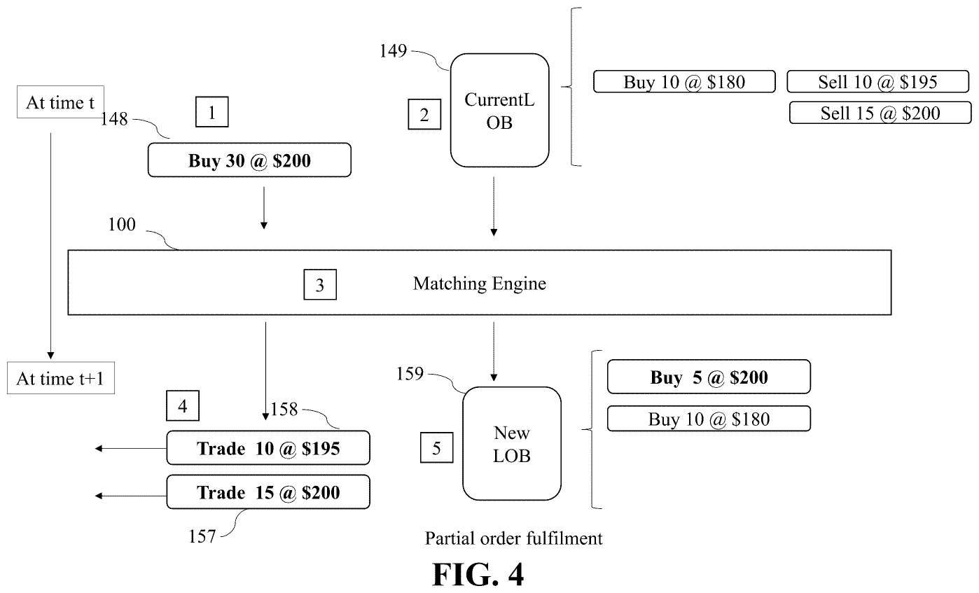

FIG. 4 is an exemplary partial order fulfilment operation of the matching engine according to prior art. Step 1: New buy order 148 arrives at matching engine 100 at time t with a bid of 30 stocks at $200. Step 2: Matching engine 100 retrieves current LOB 149 which consists of a buy order comprised of 10 stocks at $180, sell order of 10 at $195 and sell order of 15 at $200. Step 3: Matching engine compares new buy order 148 with current LOB 149 to see if there is a price march with a sell order. It determines that the order can be partially fulfilled with the two sell orders. Step 4: The trade is executed at boxes 157 and 158 by trading 10 of the stocks at $195, and 15 at $200. Step 5: Matching engine 100 updates the order book to LOB 159, by removing both sell orders, and including the unfulfilled 5 stocks as a buy order at $200.

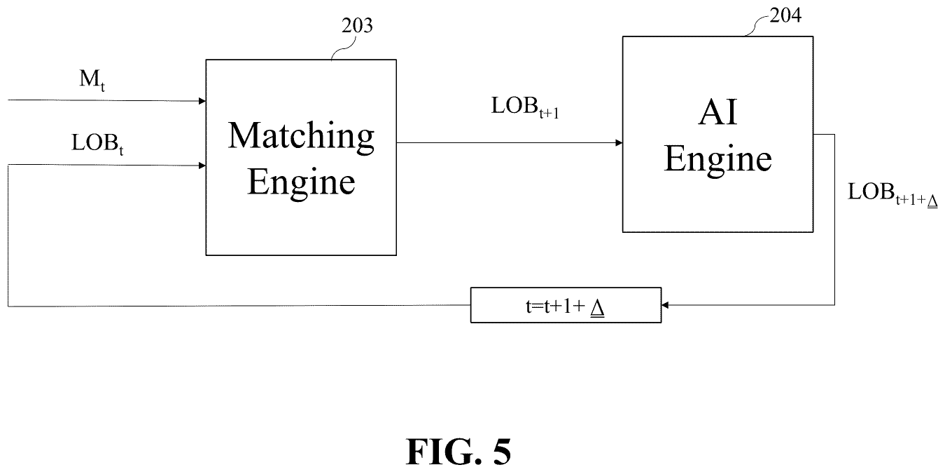

FIG. 5 illustrates key sequence of operations of the exchange simulator by matching orders and generating LOB in a feedback loop according to an aspect of this invention. First, matching engine 203 receives for security i a new order, Mⁱₜ and LOBⁱₜ wherein LOBⁱₜ is generated by AI engine 204 at time t. The new order, Mⁱₜ is represented by a vector with seven key elements. These elements are as follows (their indices of i and t are not shown for simplicity of expression):
1. T_{d:}: Trader identifier. This field is not used during AI training.
2. T: Time. Decimal precision up to nanoseconds depending on request period.
3. T_{y}: Type. Values are: 1: New; 2: Cancellation/Partial deletion; 3: Deletion; 4: Execution of a visible order; 5: Execution of a hidden order; 7: Trading halt indicator.
4. I_{d}: Order identifier (Assigned in order flow).
5. S: Quantity.
6. P: Price.
7. D: Direction: −1: Sell; 1: Buy.

$${{M}^{i}}_{t} = {{[ \begin{matrix}{T}_{d} & T & {T}_{y} & {I}_{d} & S & P & D\end{matrix} ]}^{i}}_{t} \qquad [ 1 ]$$

In another embodiment, Mⁱₜ may include fewer number of elements. An exemplary list of order messages of Amazon stock is given in Table 1 (The trader identifier is not shown for privacy). All these new orders arrive at the same time Tt. The order quantities, prices and directions are different.

TABLE 1

| Time | Type | Order ID | Quantity | Price | Direction |
|---|---|---|---|---|---|
| 34200.18960 | 1 | 11885113 | 21 | 2238100 | 1 |
| 34200.18960 | 1 | 3911376 | 20 | 2239600 | −1 |
| 34200.18960 | 1 | 11534792 | 100 | 2237500 | 1 |
| 34200.18960 | 1 | 1365373 | 13 | 2240000 | −1 |
| 34200.18960 | 1 | 11474176 | 2 | 2236500 | 1 |
| 34200.18960 | 1 | 1847685 | 100 | 2240000 | −1 |
| 34200.18960 | 1 | 3920359 | 15 | 2236000 | 1 |
| 34200.18960 | 1 | 3578212 | 4 | 2240000 | −1 |
| 34200.18960 | 1 | 4632045 | 100 | 2235000 | 1 |
| 34200.18960 | 1 | 3581197 | 10 | 2240000 | −1 |
| 34200.18960 | 1 | 3554251 | 50 | 2234900 | |

If matching engine 203 can't find a match, Mⁱₜ is simply appended to LOBⁱₜ according to its price and arrival time. If there is a match or partial match, then LOBⁱₜ is modified accordingly (as explained in examples of FIGS. 3 and 4). If order Mⁱₜ is a cancel order, the corresponding order is deleted from the LOB. As a result, matching engine 203 generates the new LOB t+1, which is then an input to AI engine 204. At time t+Δ, AI Engine 204 generates a new LOB, LOBⁱₜ₊₁₊Δ, ready for the new order Mⁱₜ₊₁₊Δ. Note that the given all order messages received from to (time zero) to time t, the state of the LOB at each incremental time is deterministic as order fulfilment rules are fixed.

While some market participants want to sell an asset, other participants want to buy. This order transitioning causes the LOB to evolve in time, and the asset price to fluctuate as new orders come in and as trades take place. If far more participants want to sell, then the price of the asset declines, and vice versa. When there is good liquidity in the LOB, there will be a liquidity generator 209 is an HFT subsystem significant number of buy/sell activities.

One possible representation of LOBⁱₜ is a matrix of order N×4L where L is the number of represented price levels (e.g., if there are only 2 levels of pricing represented in the LOB, aka only Levels 1 and 2, then L=2). At each price level, there are four records, namely, sell (ask) price, sell (ask) size (or volume), buy (bid) price and buy (bid) size (volume). In an exemplary scenario of 2 price levels, there are 8 columns in each record of the LOB. N is the number of records (order messages) pending in the LOB at time t. The price and volume data are denoted as follows:
P_{b}(1): Sell Price 1: Level 1 Ask Price (Best Ask)
V_{b}(1): Sell Size 1: Level 1 Ask Volume (Best Ask Volume)
Pₐ(1): Buy Price 1: Level 1 Bid Price (Best Bid)
Vₐ(1): Buy Size 1: Level 1 Bid Volume (Best Bid Volume)
P_{b}(2): Sell Price 2: Level 1 Ask Price (Best next Ask)
V_{b}(2): Sell Size 2: Level 1 Ask Volume (Best next Ask Volume)
Pₐ(2): Buy Price 2: Level 1 Bid Price (Best next Bid)
Vₐ(2): Buy Size 2: Level 1 Bid Volume (Best next Bid Volume)
   Accordingly, the j^{th} row (record) of LOBₜ is:

$${{LOB}^{i}}_{t} ( j ) = [ \begin{matrix}{{P}_{b}}^{j} ( 1 ) & {{V}_{j}}^{i} ( 1 ) & {{P}_{a}}^{j} ( 1 ) & {{V}_{a}}^{j} ( 1 ) & {{P}_{b}}^{j} ( 2 ) & {{V}_{b}}^{j} ( 2 ) & {{P}_{a}}^{j} ( 2 ) & {{V}^{j}}_{a} ( 2 )\end{matrix} ] \qquad [ 2 ]$$

$$j = 1 … N$$

$$i = 1 … D$$

where N is the number of records in the LOB and D is the number of assets in an asset group. As an example, LOBₜ and LOBₜ₊₁ corresponding to FIG. 4 have two price levels (L1 and L2), i.e., 8 rows, and represented as follows:

$${LOB}_{t} = [ \begin{matrix}180 & 10 & 195 & 10 & 0 & 0 & 200 & 15\end{matrix} ] \qquad [ 3 ]$$

$${LOB}_{t + 1} = [ \begin{matrix}200 & 5 & 0 & 0 & 180 & 10 & 0 & 0\end{matrix} ] \qquad [ 4 ]$$

Note that zeros are padded for those orders that do not have corresponding buy or sell activity. There may be other possible representations of an order message and LOB. The vector and matrix notations are used purely to show a possible structuring of the data.

Many respected studies show that financial markets are, to some extent, predictable. There are two classes of approach attempting to forecast financial markets: statistical parametric models and data-driven machine learning models. The more traditional statistical models generally assume that the market follows a time-series that is generated from a parametric process. There is, however, agreement that stock returns behave in a more complex way, typically highly nonstationary and nonlinear, and noisy.

Machine learning techniques easily capture stochastic nonlinear relationships with almost no prior knowledge regarding the input data [see Atsalakis et al., “Surveying stock market forecasting techniques-Part II: Soft computing methods,” Expert Systems with Applications, 2009]. Some of the earlier work on applying machine learning had focused on extracting representative features. The most recent work to Peer et al., “Generative AI for End-to-End Limit Order Book Modelling: A Space Network,” CAIF '23; and Zhang et al., “DeepLOB: Deep Convolutional Neural Networks for Limit Order Books,” 2019, however, shows that deep learning leads to much better results than extracting most important features inherent in raw data. Even when new assets are added to the system, the system can perform successful predictions. The Convolutional Neural Network (CNN) is one approach that has been successfully applied to financial data. It is most popular for image recognition and object tracking applications. The Long Short-Term Memory (LSTM) is yet another approach that is widely used in modeling sequential data with long-term relationship (i.e., dependency to past data). LSTM model has been widely popular in recent years, to analyze financial data. LSTMs are a type of recurrent neural network (RNN) that excel at handling sequential data and learning long-term dependencies. This makes them best suited for tasks like machine translation, speech recognition, and text summarization. Generative AI models often outperform LSTMs in tasks that require understanding long-range dependencies in data sequences. They can use parallel processing which makes them even more suitable to train on large datasets. Generative models are unique as they can generate completely new content from the learning the behavior of data. An autoregressive generative model is suitable for the AI model of this invention.

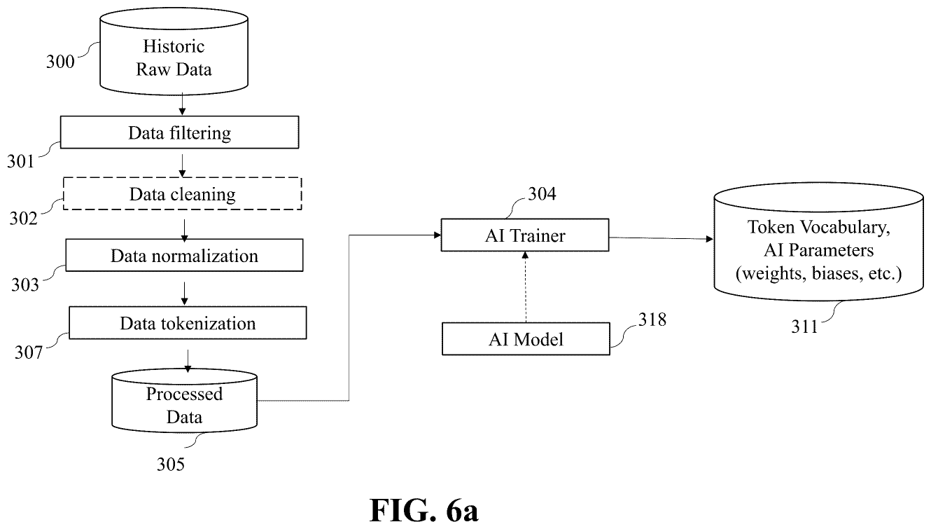

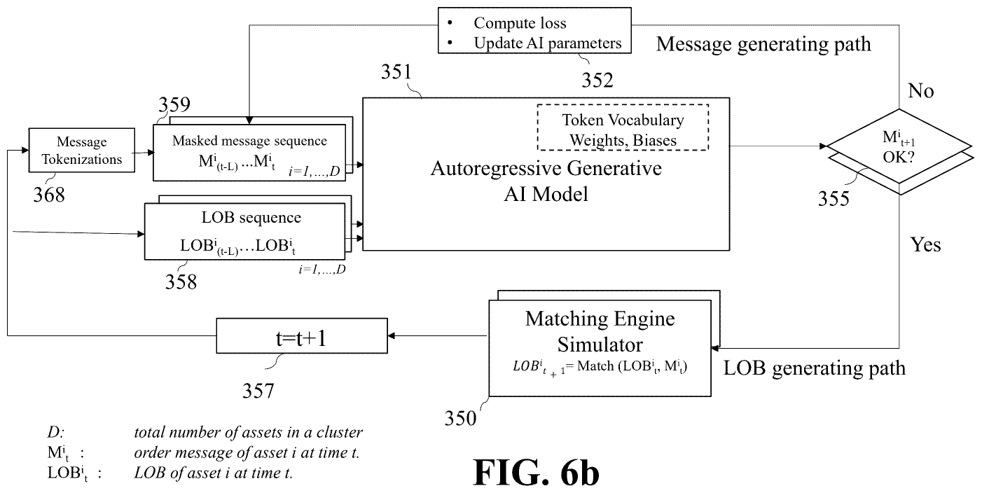

FIG. 6a illustrates the offline training of the AI engine according to an aspect of the present invention. Training a machine learning model requires a vast amount of historic raw financial data 300 to accomplish the task. There are two popular datasets for financial markets, namely FI-2010 and LOBSTER datasets that have order data. FI-2010 is a publicly available free dataset that contains ten consecutive days of orders of five different stocks taken from NASDAQ Nordic market. LOBSTER is a fine granularity NASDAQ LOB data that has a large amount of useful data for AI training. LOBSTER is obtained from NASDAQ's TotalView-ITCH feed data. It builds a snapshot of the order book at any given time. This snapshot shows the buy and sell orders currently available, along with their price and quantity. In addition to these datasets, this invention uses a large historic dataset obtained from Borsa Istanbul (BIST).

The raw training data must first go through a rigorous process. In box 301, the data irrelevant to AI training is removed. HFT algorithms often submit and cancel large numbers of limit orders over short periods of time as part of their trading strategies. These actions often result in deep LOBs with a huge amount of data. However, according to prior-art, over 90% of all orders end up being canceled rather than being matched. Therefore, those levels further away from Level 1 are much less useful in predicting the LOB. In addition, the prior work suggests that Level 1 (best ask and best bid) contributes most to order matching and price setting. The contributions of all other levels are considerably less, estimated as little as twenty percent. As a result, it would be unwise to feed the information contained in all levels of a LOB, as these levels are much less useful. Data filtering 301 may completely omit deeper levels. Alternatively, it can smooth it out by summarizing the information contained in those deeper levels. For example, finite impulse response (FIR) filters used in signal processing are popular smoothing techniques for de-noising information in deeper levels, and they are simple to implement.

The optional, data cleaning 302 identifies and corrects errors, inconsistencies, and inaccuracies within the data set. It essentially prepares the data for analysis by removing or modifying incorrect, incomplete, irrelevant, duplicated, or mis-formatted data. The financial data is usually extremely clean and may not require the data cleaning step. However, when other types of optional data are used in addition to order data, such as news data, they may require data cleaning. Thereafter, data normalization 303 normalizes the values in data fields. For example, all dollar values may be converted to cents, and further normalized by dividing the price values to the average of sell and buy prices. This process flattens price ranges. The filtered, cleaned and normalized data is then transferred to data tokenization 307. In the realm of Artificial Intelligence, particularly in Natural Language Processing (NLP), tokenization refers to the process of breaking down text into smaller units called tokens which can be words, sub-words, characters, or data fields. This is a fundamental step in preparing the order messages to split them up (or ‘parsing’ them) into proper data fields that are assigned as tokens. Please see Eq. 1 for exemplary proper data fields of an order message. Finally, the tokenized data is stored in processed datastore 305.

AI Trainer 304 is offline trained using only processed data. The input and output of the AI Trainer 304 are simply time stamped messages and LOB sequences. The tokens and parameters of AI Model 318 are stored in AI Parameters 311. These parameters are updated as new data is made available to the training system. If AI Model 318 changes, the AI training steps must be re-executed according to the new model to re-estimate the neural network parameters such as weights and biases. As time progresses, the AI trainer updates the model through another training cycle when additional data is made available. The periodicity of AI training cycle depends on implementation.

FIG. 6b illustrates an exemplary offline AI training system using an autoregressive generative AI Model 351 [see Peer et al.]. The first input to the system is the masked message sequence 359 after a proper tokenization that is performed according to message tokenizations 368 for one asset or a group of assets. The second input to the system is the LOB sequence 358 corresponding to said message sequence. The message sequence is fed to the system from processed dataset 305 of FIG. 6a. Masking means some elements within the order message are intentionally masked or hidden from the model. According to chosen method, random elements, every other element or specific elements may be masked. Masked message sequences are a valuable technique for training AI models that deal with sequential data. By forcing the model to predict those masked/missing elements, it encourages them to learn the underlying structure and relationships within the data, leading to improved prediction performance.

Note that the LOB sequence 358 corresponding to message sequence 359 is generated by matching engine (or LOB simulator) 350 that can take the LOB of the previous time (t) and the message sequence of previous time (t), and match to generate the current LOB at time (t+1). Note that time is incremented in box 357, meaning the new time (t) is time (t+1) in the recursive process. The new LOB sequence 358 corresponding to time t+1 as well as the actual message sequence 359 corresponding to time t+1, after tokenization is performed in 368, are used as input to Autoregressive Generative AI Model 351. The model uses tokenization to generate a token vocabulary to address various relevant fields of the order message. While the generated LOB sequences are used directly, the real message sequences are first encoded before providing them as input to the AI model. During this encoding process, message tokenization is performed to create a token vocabulary to address and dissect various fields of the message. Messages are then masked (some fields are removed), and inputs are created for the generative AI model to identify these masked fields. The model performs predictions on the masked data, which facilitates the learning process.

Note that the progression of the state of the LOB in time can be wholly reconstructed given an initial LOB state (at time t₀) and the total set of arriving order messages in a time interval as an ordered set (at time t₁, t₂, t₃, etc.). The ‘message generating path’ of AI trainer allows to generate new messages based on training (M), and as a corollary it generates new LOBs through LOB generating path. A loss function determines the error, e, between the actual Mₜ₊₁ and AI estimated \hat{M}ₜ₊₁ (i.e., e=Mₜ₊₁−\hat{M}ₜ₊₁). Box 355 checks to determine if \hat{M}ₜ₊₁ is close enough to actual \hat{M}ₜ₊₁. If not, an objective function of minimizing the error (or a function of the error) is used to retune and re-estimate the neuron weights and biases according to step 352 until convergence is reached, or e≈0.

According to an aspect of the present invention, the AI model is offline trained on an individual asset's data. This data consists of sequences of order messages and their corresponding LOB sequences. While this can still be a significant amount of data, it allows AI to be trained for each asset independently. For multiple assets, the training process can be done one after the other (sequentially) or all at once (in parallel). This method is innovative and highly efficient because it breaks down the problem into smaller, more manageable pieces.

According to another aspect of this invention, the system offline trains the AI model on groups of related assets instead of individual assets, as shown in FIG. 6b. This is because prices of certain assets often move together. For example, companies in the same industry might see their stock prices rise or fall together due to similar events, like a new law or changing consumer preferences. Imagine gas prices surging—this could cause stock prices for all electric vehicle companies to jump. A number called the ‘correlation coefficient’ is used to measure how closely two asset's prices move together. These coefficients can be found online or calculated using historical price data. A coefficient of +1 means the assets always move in the same direction by similar amounts, while −1 means they always move in opposite directions. A value closer to 0 shows little to no connection between two assets. In this approach, assets with a strong correlation (with an absolute value of correlation coefficient close to one) are grouped together, and the AI model is trained for that entire group (as in FIG. 6b). We assume that each training group has D number of highly correlated assets. Just like in the first approach, training can be done independently and all at once (in parallel) for each training group. In fact, the first method is simply a special case of each group having one asset (D=1).

Although an autoregressive generative model is recommended in this invention, other possible AI models are not ruled out as the research and development in machine learning is advancing rapidly. Same processed data 305 can be used to test various model alternatives.

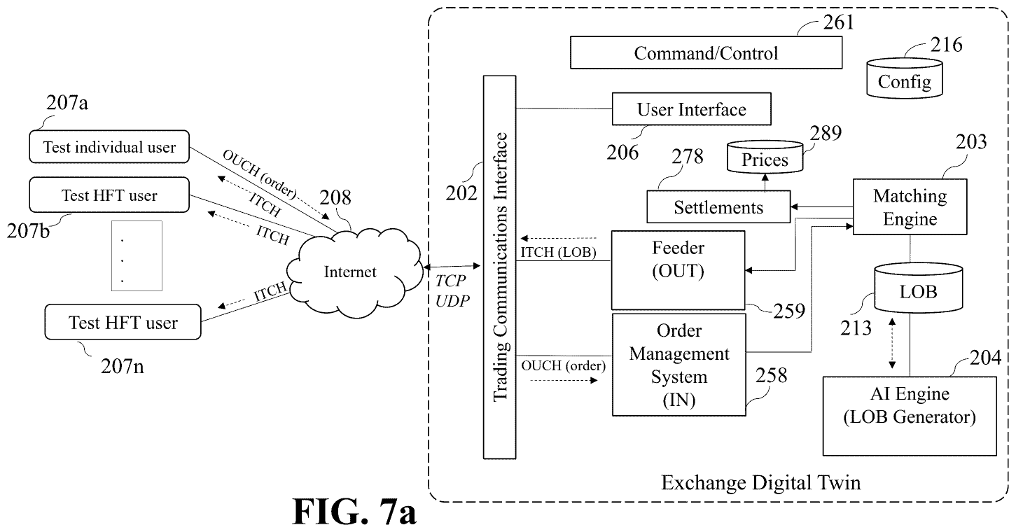

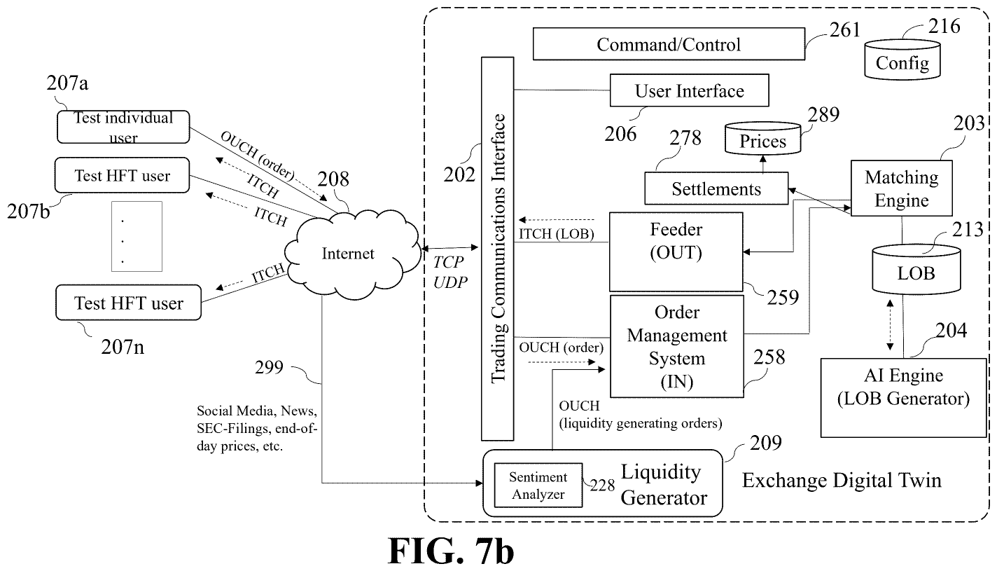

FIG. 7a shows the block diagram of the first embodiment of the system of invention. The system has several key components. Matching engine 203 performs matching of newly arrived order messages with the current LOB. The current LOBs for certain stocks in circulation are stored in LOB dataset 213. AI Engine 204 receives a LOB as an input and generates the next LOB as an output. Order management system 258 receives and pipelines all new order messages for the processing of matching engine 203. The input is in the form of an order entry message (e.g., OUCH). The output of order management system 258 is suitably formatted order message for processing of matching engine 203.

Matching engine 203 performs matching and sends the updated LOB to AI Engine 204 so that a new LOB is generated accordingly. Matching engine 203 then transmits the new LOB to Feeder 259 which processes the LOB in the form of a real-time exchange data message (e.g., ITCH) to be multicasted to all test users trading the same asset. If a matching occurs, a trade takes place. This is simulated by settlements 278 which updates the price of the stock accordingly, and stores in 289. Although there isn't a settlement per se, because assets and currencies are not physically exchanged, settlement 278 simulates the entire transaction to calculate and report profits and losses for test scenarios. Trading communications interface 202 connects the system to Internet with IP protocol.

Test users 207a, 207b and so on (207n), connect to the system through Internet 208 via a wireline or wireless network connection. Test users may be local or remote. Wireline connection may be a private line using fiber optics. The wireless network connection may be WiFi or cellular. Test users use a graphical client application that runs on a computer. Test users are provided user interface 206 with functionality to enter or cancel a plurality of orders, and to view important data such as transaction status, profits and losses, and current LOB. The system further has a configuration database 216 that stores system configuration data such as number of active test user licenses, user information, system capacities, operational restrictions, security settings etc. Command/Control 261 allows to control the system locally or remotely.

FIG. 7b shows a high-level block diagram of another embodiment of system of invention that has liquidity generator 209 and sentiment analyzer 228. The rest of the components of the system are identical with the first embodiment of FIG. 7a, and thus will not be repeated here. Liquidity generator may receive additional real-time market information such as financial news, social media and SEC-filings to determine if there are any financial information that may impact the general direction of stock prices. Sentiment analyzer 228 receives such additional market information as input and provides an impact score on a specific stock or category of stocks that may be impacted at the current time. More specifically, liquidity generator may react to market-changing key events such as natural disasters, pandemics, geopolitical events, regulation changes, and technology disruptions through sentiment analysis. These real-time events are likely not captured by the AI engine as it occurs in the present time. Liquidity generator may also receive through interface 299 end-of-day stock prices, including open, high, low, and close that are published in NASDAQ webpages or provided by financial news outlets. Liquidity generator 209 may generate large number of order messages in addition to order messages of test users 207a, 207b, . . . 207n to tilt the market direction according to said additional market information. Liquidity generator 209 may be configured or triggered to generate additional liquidity for certain securities during testing. The configuration may be performed by the system as well as test users.

In the first embodiment, liquidity generator 209 is a market maker that generates orders for which test participants trade against. This is essentially an automated agent that submits large orders at various price levels based on the LOB generated by the AI engine and/or additional market information such as financial news. While entering the orders, an automated agent enters reasonable buy and sell prices to correspond to the market conditions.

According to the second embodiment, liquidity generator 209 is random order generator subsystem that emulates a group of individual investors who randomly generates buy and sell orders spread out over time. The statistical distribution of order types (limit, stop, market), order sizes, prices, and timing are used to generate a stochastic model for arrival times of orders.

According to the third embodiment, liquidity generator 209 is a HFT subsystem that simulates the behavior of high-speed traders by using algorithms like those used by such traders providing arbitrage and predatory trading. Effects of network delays and computational latency can be incorporated by introducing many HFTs.

In one possible embodiment, only one kind of liquidity generator 209 can be used. In another embodiment, a combination of several types of liquidity generators 209 can be used wherein orders are generated by all of them. The liquidity generator 209 may also be completely removed from the system or configured through a user interface in various ways.

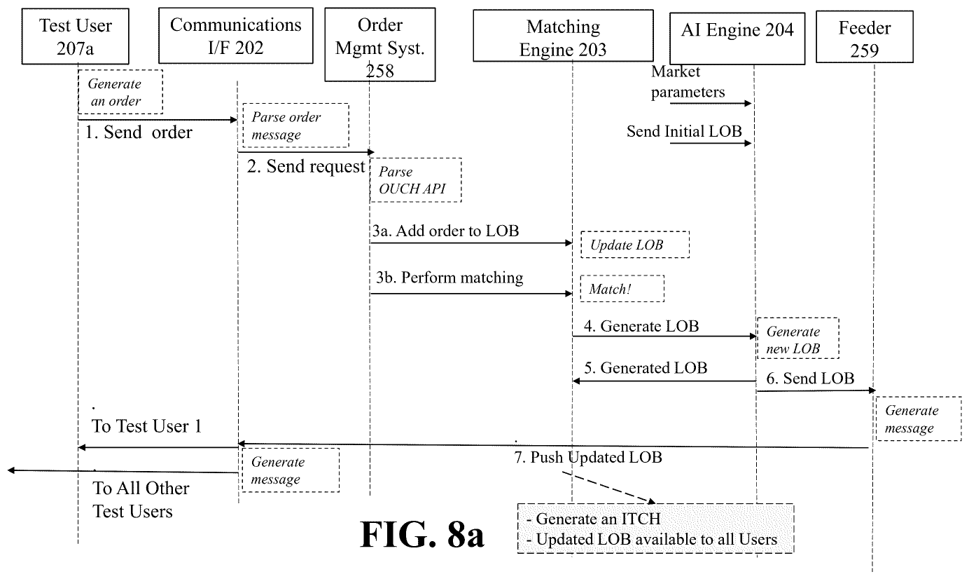

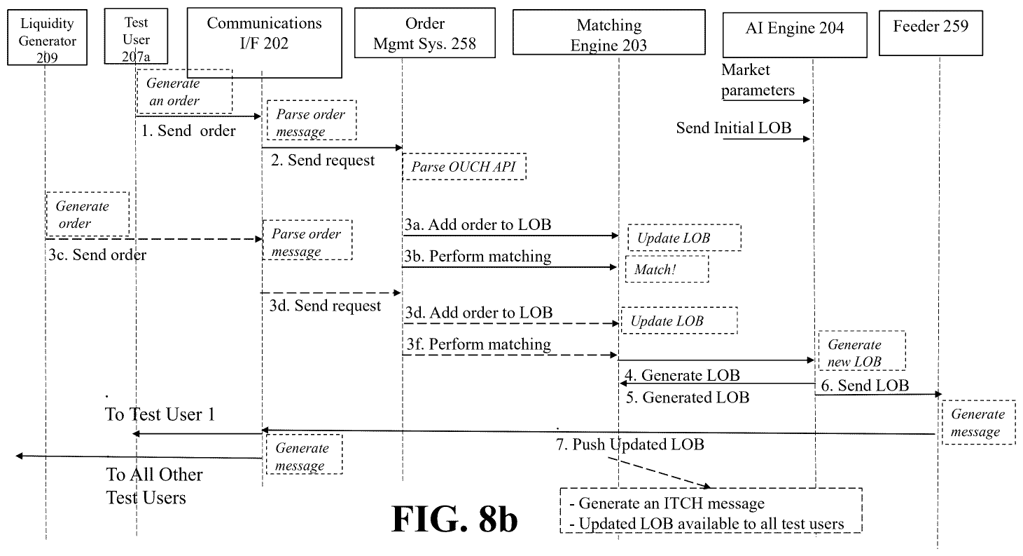

FIG. 8a shows an exemplary messages flow corresponding to the first embodiment shown in FIG. 7a. The process starts when test user 207a generates and sends an order message to the system. Communications I/F 202 parses the message and sends the content to order management system 258 in step 2. Order management system, in turn, parses the message and retrieves the order message fields. Subsequently, in step 3a, it sends the order to matching engine 203, which in turn updates the current LOB. Matching engine 203 performs the matching upon request from order management system in step 3b. If there is a match, it updates the LOB by removing the orders corresponding to the trade. Although not shown in the flow, at this junction, settlement 278 may capture the new stock price, loss and profit data, and so on. Otherwise, it appends the order according to its price and time of arrival to the current LOB.

In step 4, matching engine 203 sends the updated current LOB to AI engine and requests a corresponding ‘next’ LOB. In turn, AI engine 204 generates a new LOB, and sends the generated new LOB in step 5 to matching engine 203, which then stores it. Matching engine 203 sends the new LOB to feeder 259 for distribution to test users. In turn, feeder 259 formats the new LOB and sends it to communications I/F, which in turn performs proper protocol mappings and multicasts to other test users. An important aspect of this invention is that the new LOB generated by the AI engine captures all other possible orders that would have entered the system deduced from experience emulating the real market dynamics that is learnt through training.

FIG. 8b shows an exemplary messages flow corresponding to the second embodiment shown in FIG. 7b. The process starts when test user 207a generates and sends an order message to the system. Communications I/F 202 parses the message and sends the content to order management system 258 in step 2. Order management system in turn parses the message and retrieves the order message components. Subsequently, in step 3a, it sends the order to matching engine 203, which in turn updates the current LOB. Matching engine 203 performs the matching upon request from order management system in step 3b. After test user's order, in step 3c., liquidity generator 209 generates a large order and sends it to communications I/F as in steps 3a and 3b. The order management system requests addition of the order to the current LOB and the matching in steps 3d and 3f. The LOB used for this process may be the LOB that the previous message has added (said newly generated), or the final LOB that was generated by the AI engine. Either scenario is possible. Note that the new LOB generated by the AI engine captures all other possible orders entered the system if there were a said newly updated LOB provided as input to the AI engine.

If there is a match, it updates the LOB by removing the orders corresponding to the trade. Although not shown in the flow, at this junction, settlement 278 captures the stock price, loss and profit data and so on. Otherwise, it appends the order according to its price and time of arrival to the current LOB.

In step 4, matching engine 203 sends the newly updated LOB to AI engine and requests a corresponding next LOB. In turn, AI engine 204 generates a new LOB, and sends the generated new LOB in step 5 to matching engine 203, which then stores it. Matching engine 203 sends the generated new LOB to feeder 259 for distribution to other test users. In turn, feeder 259 formats the new LOB in a message and sends it to communications I/F, which in turn perform proper protocol mappings and multicasts to other test users.

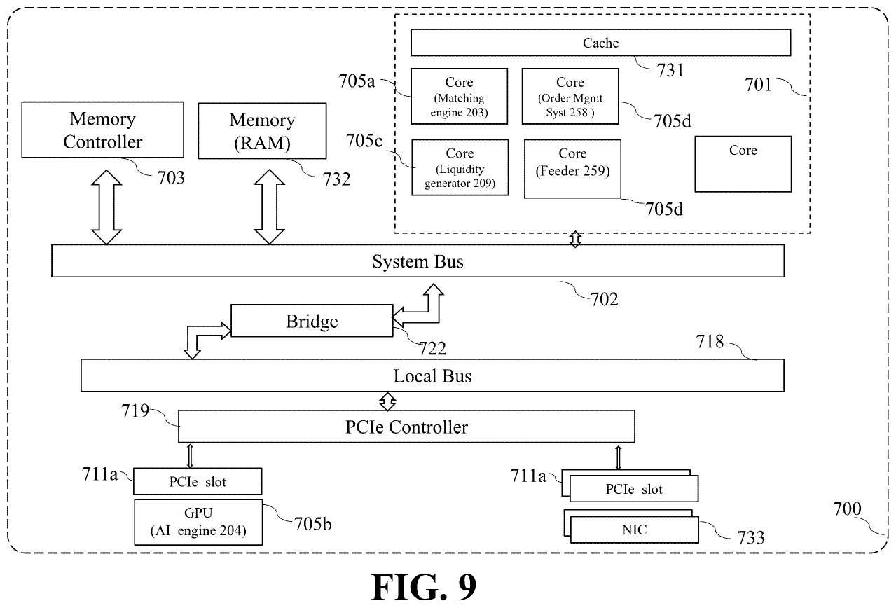

FIG. 9 depicts a simplified view of one possible embodiment of the hardware architecture of the system. The specific configurations, depending on implementation, may vary. Matching Engine 203, Order Management System 258, and AI Engine 204 need to handle complex tasks very quickly to ensure the reactiveness of the system. To achieve the required high performance, the system is designed by dividing tasks into multiple threads, with each thread being assigned to an isolated CPU (also known as ‘processor core’ or simply ‘core’). These isolated CPUs are dedicated to specific tasks through operating system configurations. The software architecture is thereby structured into modular components, minimizing the communications required between modules to enhance performance.

Parallelization across many threads is implemented for the inference phase of AI engine algorithms, which requires a substantial computational power. Graphical Processing Units (GPUs) that are built to handle multiple tasks simultaneously, are ideal for tasks that can be broken down into smaller, independent calculations. Therefore, the GPU is the optimal choice for the AI engine of this embodiment. According to an aspect of this invention, a mixed architecture, utilizing both isolated CPUs (cores) and the GPU is depicted for the system.

The system hardware follows the standard architecture of computer 700. CPU 701 is the Central Processing Unit. System Bus 702 is the high-speed bus that connects CPU 701 and GPU 705b directly to Main Memory (RAM) 731 for internal data transfers. System Bus 702 carries critical data, memory addresses, and control signals. Memory Controller 703 is the component that manages communication between CPU 702 and Main Memory 732 and/or Cache 731. In some systems, it might also handle local bus functions. Network Interface Card (NIC) 733 are responsible for communication over network.

Matching Engine 203 runs on Core 705a, and Order Management System 258 runs on Core 705d. The optional Liquidity Generator 209 and Feeder 259 may run on Core 705c and Core 705d, respectively, as they all require high-performance processing. AI Engine 204 runs on an external GPU (CPU 705b) that attach directly to main computer 700 through PCIe slot 711a. Other software components such as the Feeder 259 and User Interface run on other CPUs of main computer 700. Typically, the TCP/IP stack is implemented as part of the Operating System (OS) that resides in the CPU.

Local Bus 718 connects the CPU and Memory Controller to GPUs and Network Interface Cards (NICs). PCIe controller 719 translates signals between Local Bus 718 and the high-speed PCIe interface. Bridge 722 is a central hub providing data flow between system bus 702 and local bus 718 for interconnecting the CPU and other high-performance components like the GPU and NICs. When the CPU 701 needs to interact with an GPU, it sends a request and address information over System Bus 702. Bridge 722 receives the request and routes it to the memory controller (if memory is involved) or local bus devices. Finally, PCIe controller 719 translates the signals into the appropriate format for the high-speed PCIe interface. Data is transferred between the CPU and the GPU through the PCIe interface. The connection of a plurality of users to the system is achieved through one or more NICs 733. Each NIC supports a TCP/IP network through which one or more users may connect to the system. Said connection may be a wireline (e.g., fiber), wireless (e.g., WiFi), or cellular (e.g., 5G). The users may be local or remote. Although the system depicts only one CPU and GPU, the system capacity may be increased by adding more CPU and GPU, as needed.

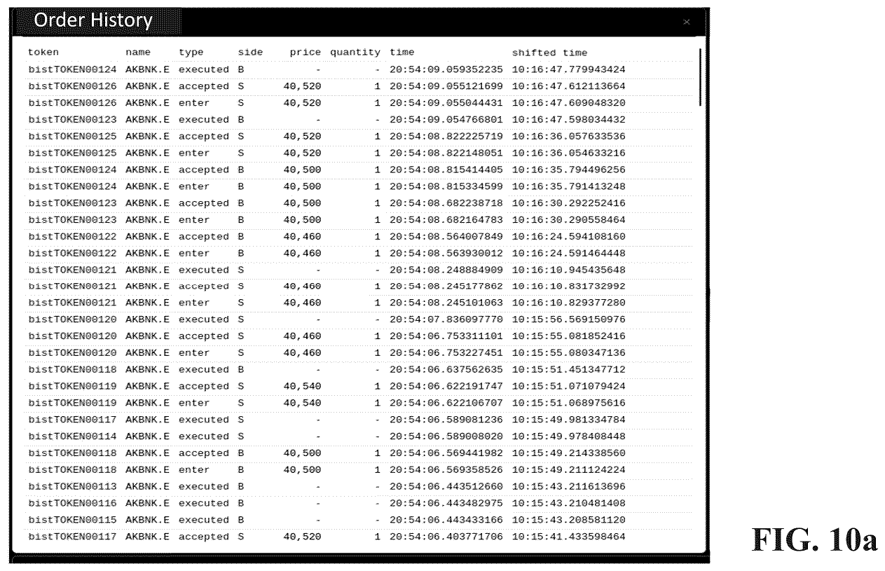

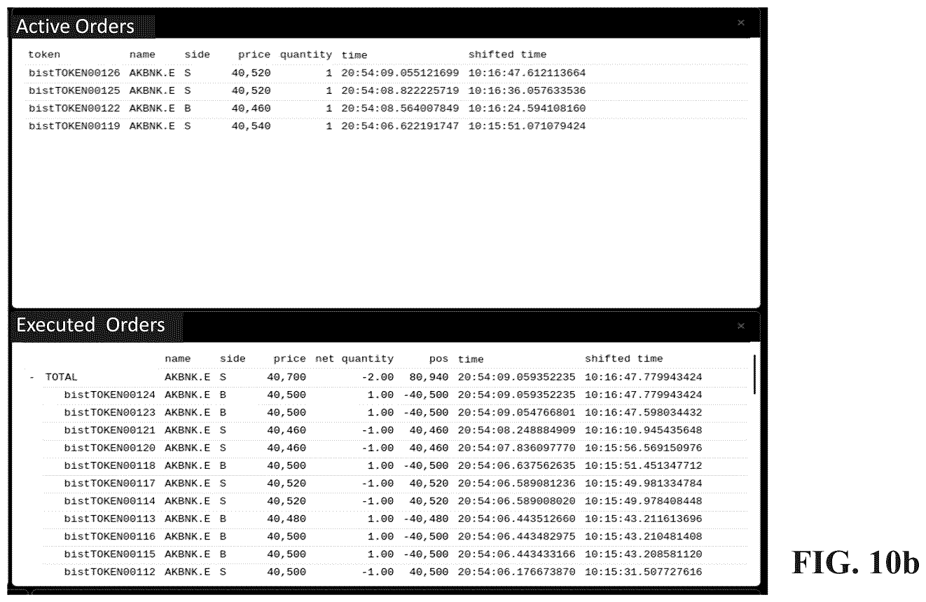

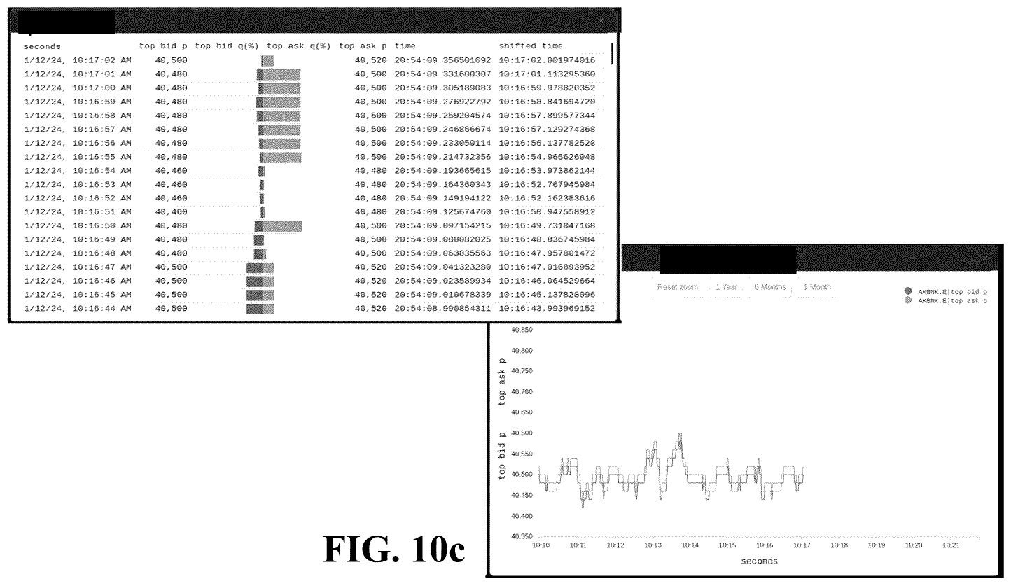

FIGS. 10a and 10b depict exemplary screen shots of the user interface showing the LOB for Garanti E stock traded in Borsa Istanbul (BIST). FIG. 10a shows the order history. The user can request the ordering of messages according to time, price, or first price then time, or other parameters such as type, direction and trader Id. In FIG. 10b, the orders are displayed in two panels, namely active orders (those not executed yet) and executed orders. User can view these orders on separate panels. The user can click on any order and see order details. One of the important outcomes of the model is price variation over time. FIG. 10c shows prices over time in list and graph views. The user interface provides many other capabilities such as generating a list of orders, sending order messages to the system for fulfillment or cancellation, executing many what-if-scenarios, and so on. Each user can configure his/her/their user interface panels and the type of data shown.

In one embodiment, the present invention provides an article of manufacture having non-transitory computer readable storage medium comprising computer readable program code executable by a processor to implement an exchange simulator for forward testing on future market conditions generating limit order books (LOBs), and having no direct attachment to any real exchange to receive real-time market order data, the medium comprising: (a) computer readable program code receiving, at a communication interface of the exchange simulator, a plurality of order messages from a plurality of test client devices; (b) computer readable program code parsing the plurality of order messages and outputting a plurality of parsed order messages to an order manager; (c) computer readable program code receiving the parsed order messages at a matching engine associated with the exchange simulator, and adding to a current limit order book (LOB), the current LOB being generated by an artificial intelligence (AI) engine; (d) computer readable program code matching the parsed order messages using a matching engine and updating the current LOB; wherein the matching engine applies one or more rules associated with the simulated exchange during matching; (e) computer readable program code sending the updated current LOB to AI engine; wherein the AI engine generates a new LOB to simulate market reaction to said current LOB; (f) computer readable program code receiving the new LOB at a feeder and generating an outbound message comprising the new LOB; and (g) outputting, via the communication interface, the outbound message comprising the new LOB message to the plurality of test client devices. In this context, parsing means reading the data/fields from the order messages.

In another embodiment, the present invention provides a system acting as an exchange simulator for forward testing on future market conditions generating limit order books (LOBs) s and having no direct attachment to any real exchange to receive real-time market order data, having at least: (a) a memory; (b) a central processing unit (CPU) comprised of at least three cores wherein each core having a different function and acting independently, the CPU comprising: (i) a first core implementing an order management system, receiving order messages from a plurality test client computing devices; (ii) a second core implementing a matching engine that matches incoming orders to execute simulated trades; (iii) a third core implementing a feeder, sending the LOBs to test users; (c) a graphical processing unit (GPU) implementing an AI engine; wherein computer readable program code stored in the memory, which when executed by the CPU: (1) receives, via a communication interface associated with the first core of the CPU, a plurality of order messages from a plurality of test client devices; (2) parses the plurality of order messages via the first core of the CPU and outputting a plurality of parsed order messages; (3) receives the parsed order messages at the second core of the CPU, and adding to a current limit order book (LOB), the current LOB being generated by an artificial intelligence (AI) engine; (4) matches the parsed order messages using the second core of the CPU and updates the current LOB; wherein the second core applies one or more rules associated with a simulated exchange during matching; (5) sends the updated current LOB to the AI engine on the GPU; wherein the AI engine generates a new LOB to simulate market reaction to said current LOB; (6) receives the new LOB at the third core of the CPU and generates an outbound message comprising the new LOB; wherein the third core of the CPU sends the outbound message comprising the new LOB to the plurality of test client devices.

In one embodiment, the AI engine is trained offline with a large training dataset of historic order messages obtained from an exchange being simulate

In one embodiment, the offline training is performed per security asset to generate a LOB corresponding to the security asset, and wherein the offline training being performed either serially or in parallel for all security assets.

In one embodiment, the offline training is performed per security asset group of highly correlated securities to generate LOBs corresponding to the security asset group, wherein the offline training being performed either serially or in parallel for all security asset groups.

In one embodiment, the highly correlated securities in the security asset group are identified by their correlation coefficient being close to +1, wherein the highly correlated securities in the security asset group tend to move in a same or opposite price direction by similar amounts.

In one embodiment, offline training is performed by a training system using a time series of historic order messages and corresponding time series of order books as input, and the next order book in the time series as output.

In one embodiment, the historic order messages are first tokenized and then masked before being used as input into the training system.

In one embodiment, the time series of order book is deterministic and generated by a matching engine (LOB) simulator using the time series of order messages.

In one embodiment, the parsed order messages are additionally generated by an internal liquidity generating agent generating bulk orders to improve liquidity in the current LOB.

In one embodiment, the matching engine matches buy and sell orders according to current LOB using the one or more rules associated with the simulated exchange during matching.

In one embodiment, the internal liquidity generator has a sentiment analyzer reacting to market-changing key events such as natural disasters, pandemics, geopolitical events, regulation changes, and technology disruptions by processing additional market information such as news, social media feeds and regulatory filings, and determining an impact score on a specific security.

In one embodiment, the liquidity generator is further configurable as one of a market maker, random order generator or a high frequency trader, or a combination thereof.

The above-described features and applications can be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor. By way of example, and not limitation, such non-transitory computer-readable media can include flash memory, RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. The computer readable media does not include carrier waves and electronic signals passing wirelessly or over wired connections.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The sequence of such executable instructions or associated data structures represents examples of corresponding acts for implementing the functions described in such steps.

Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be a physical server, or a virtual server partitioned on a physical server using a virtualization software. The computer may be dedicated to the system or share other functions.

In this specification, the term “software” is meant to include firmware residing in read-only memory or applications stored in magnetic storage or flash storage, for example, a solid-state drive, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example is produced by a compiler, and files including higher-level code that are executed by a computer, an electronic component, or a microprocessor using an interpreter.

While the above discussion primarily refers to multi-core processors that execute software, some implementations are performed by one or more integrated circuits, for example application specific integrated circuits (ASICs) or field programmable gate arrays (FPGAs). These are not excluded from the invention.

As used in this specification and any claims of this application, the terms ‘computer’, ‘processor’, and ‘memory’ all refer to electronic or other technological devices. For the purposes of the specification, the terms display or displaying means displaying on an electronic device. As used in this specification and any claims of this application, the terms ‘computer readable medium’ and ‘computer readable media’ are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The computing system can include clients and servers. A client and server are generally remote from each other and typically interact through a communication network. The relationship of client and server arises by virtue of computer programs running on the respective computers and having a client-server relationship to each other. In some aspects of the disclosed subject matter, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components illustrated above should not be understood as requiring such separation, and it should be understood that the described program components and systems can generally be integrated together in a single software product or packaged into multiple software products.

### CONCLUSION

A system and method have been shown in the above embodiments for the effective implementation of a system, method and article of manufacture for a dynamic exchange simulator. While various preferred embodiments have been shown and described, it will be understood that there is no intent to limit the invention by such disclosure, but rather, it is intended to cover all modifications falling within the spirit and scope of the invention, as defined in the appended claims. For example, the present invention should not be limited by software/program, computing environment, or specific computing hardware.

What is claimed is:

1. An article of manufacture having non-transitory computer readable storage medium comprising computer readable program code executable by a processor to implement an exchange simulator for forward testing on future market conditions generating limit order books (LOBs), and having no direct attachment to any real exchange to receive real-time market order data, the medium comprising:
a. computer readable program code receiving, at a communication interface of the exchange simulator, a plurality of order messages from a plurality of test client devices;
b. computer readable program code parsing the plurality of order messages and outputting a plurality of parsed order messages to an order manager;
c. computer readable program code receiving the parsed order messages at a matching engine associated with the exchange simulator, and adding to a current limit order book (LOB), the current LOB being generated by an artificial intelligence (AI) engine;
d. computer readable program code matching the parsed order messages using a matching engine and updating the current LOB; wherein the matching engine applies one or more rules associated with the simulated exchange during matching;
e. computer readable program code sending the updated current LOB to AI engine; wherein the AI engine generates a new LOB to simulate market reaction to said current LOB;
f. computer readable program code receiving the new LOB at a feeder and generating an outbound message comprising the new LOB; and
g. outputting, via the communication interface, the outbound message comprising the new LOB message to the plurality of test client devices.

2. The article of manufacture of claim 1, wherein the AI engine is trained offline with a large training dataset of historic order messages obtained from an exchange being simulated.

3. The article of manufacture of claim 2, wherein the offline training is performed per security asset to generate a LOB corresponding to the security asset, and wherein the offline training being performed either serially or in parallel for all security assets.

4. The article of manufacture of claim 2, wherein the offline training is performed per security asset group of highly correlated securities to generate LOBs corresponding to the security asset group, wherein the offline training being performed either serially or in parallel for all security asset groups.

5. The article of manufacture of claim 4, wherein the highly correlated securities in the security asset group are identified by their correlation coefficient being close to ±1, wherein the highly correlated securities in the security asset group tend to move in a same or opposite price direction by similar amounts.

6. The article of manufacture of claim 2, wherein offline training is performed by a training system using a time series of historic order messages and corresponding time series of order books as input, and the next order book in the time series as output.

7. The article of manufacture of claim 6, wherein the historic order messages are first tokenized and then masked before being used as input into the training system.

8. The article of manufacture of claim 6, wherein the time series of order book is deterministic and generated by a matching engine (LOB) simulator using the time series of order messages.

9. The article of manufacture of claim 1, wherein the parsed order messages are additionally generated by an internal liquidity generating agent generating bulk orders to improve liquidity in the current LOB.

10. The article of manufacture of claim 1, wherein the matching engine matches buy and sell orders according to current LOB using the one or more rules associated with the simulated exchange during matching.

11. A system acting as an exchange simulator for forward testing on future market conditions generating limit order books (LOBs) s and having no direct attachment to any real exchange to receive real-time market order data, having at least
(a) a memory;
(b) a central processing unit (CPU) comprised of at least three cores wherein each core having a different function and acting independently, the CPU comprising:
i. a first core implementing an order management system, receiving order messages from a plurality test client computing devices;
ii. a second core implementing a matching engine that matches incoming orders to execute simulated trades;
iii. a third core implementing a feeder, sending the LOB to test users;
(c) a graphical processing unit (GPU) implementing an AI engine;
wherein computer readable program code stored in the memory, which when executed by the CPU: (1) receives, via a communication interface associated with the first core of the CPU, a plurality of order messages from a plurality of test client devices; (2) parses the plurality of order messages via the first core of the CPU and outputting a plurality of parsed order messages; (3) receives the parsed order messages at the second core of the CPU, and adding to a current limit order book (LOB), the current LOB being generated by an artificial intelligence (AI) engine; (4) matches the parsed order messages using the second core of the CPU and updates the current LOB; wherein the second core applies one or more rules associated with a simulated exchange during matching; (5) sends the updated current LOB to the AI engine on the GPU; wherein the AI engine generates a new LOB to simulate market reaction to said current LOB; (6) receives the new LOB at the third core of the CPU and generates an outbound message comprising the new LOB; wherein the third core of the CPU sends the outbound message comprising the new LOB to the plurality of test client devices.

12. The system of claim 11, wherein the AI engine is trained offline with a large training dataset of historic order messages obtained from an exchange being simulated.

13. The system of claim 12, wherein the offline training is performed per security asset to generate a LOB corresponding to said security asset, and wherein the offline training being performed either serially or in parallel for all securities.

14. The system of claim 12, wherein the offline training is performed per security asset group of highly correlated securities to generate LOBs corresponding to the security asset group, wherein the offline training being performed either serially or in parallel for all security groups.

15. The system of claim 14, wherein the highly correlated securities in the security asset group are identified by their correlation coefficient being close to +1, wherein the highly correlated securities in the security asset group tend to move in a same or opposite price direction by similar amounts.

16. The system of claim 12, wherein offline training is performed by a training system using a time series of historic order messages and corresponding time series of order books as input, and the next order book in the time series as output.

17. The system of claim 16, wherein the historic order messages are first tokenized and then masked before being used as input into the training system.

18. The system of claim 17, wherein the time series of order book is deterministic and generated by a matching engine (LOB) simulator using the time series of order messages.

19. The system of claim 11, wherein the internal liquidity generator has a sentiment analyzer reacting to market-changing key events such as natural disasters, pandemics, geopolitical events, regulation changes, and technology disruptions by processing additional market information such as news, social media feeds and regulatory filings, and determining an impact score on a specific security.

20. The system of claim 19, wherein the liquidity generator is further configurable as one of a market maker, random order generator or a high frequency trader, or a combination thereof.
